(19) United States
(12) Patent Application Publication
(10) Pub. No.: US 2026/0187890 A1
(43) Pub. Date: Jul. 2, 2026

(54) METHOD FOR SYNCHRONIZING DIGITAL HUMAN VOICE AND LIP MOVEMENTS

(71) Applicant: Nanjing Silicon Intelligence Technology Group Co., Ltd, Nanjing (CN)

(72) Inventors: Hua Peng SIMA, Nanjing (CN); Jiahao CHEN, Nanjing (CN)

(73) Assignee: Nanjing Silicon Intelligence Technology Group Co., Ltd, Nanjing (CN)

(21) Appl. No.: 19/433,815

(22) Filed: Dec. 27, 2025

(30) Foreign Application Priority Data
Dec. 30, 2024 (CN) 202411960919.5

(51) Int. Cl. G06T 13/20; G06T 13/80; G06V 10/26; G06V 10/774; G06V 20/40; G06V 40/16; G10L 21/0208; G10L 25/57

(52) U.S. Cl. CPC G06T 13/205; G06T 13/80; G06V 10/26; G06V 10/774; G06V 20/40; G06V 40/161; G10L 21/0208; G10L 25/57

(57) ABSTRACT

The present application provides a method for synchronizing digital human voice and lip movements, relating to the field of digital human generation technology. The method comprises acquiring a source video, and preprocessing the source video to obtain audio data and image data; performing synchronization processing on audio encoding features and image encoding features by using a lip synchronization model to obtain synchronization features, wherein the audio encoding features are output by the lip synchronization model from the audio data, the image encoding features are output by the lip synchronization model from the image data, and the synchronization processing comprises linear feature projection and feature similarity calculation; and performing video generation according to the synchronization features to obtain a target video.

### CROSS-REFERENCE TO RELATED APPLICATIONS

The present application claims the benefit of and priority to Chinese patent application No. 202411960919.5 filed on Dec. 30, 2024, the content of the aforementioned applications is incorporated herein by reference in its entirety.

### TECHNICAL FIELD

The present invention relates to the field of digital human generation technology, and particularly relates to a method for synchronizing digital human voice and lip movements.

### BACKGROUND

With the rapid development of artificial intelligence technology, 2D digital human technology has become a hot topic in the plurality of fields such as virtual reality, augmented reality, games, entertainment, and education. A digital human, i.e., a virtual digital character, is capable of imitating behaviors and expressions of a real human and providing an interactive user experience. In these applications, lip synchronization technology is one of the key factors for realizing natural and smooth performance of a digital human.

Traditional 2D digital human generation algorithms usually rely on pre-recorded animations or simple deformation technology to simulate mouth shapes, but these methods are difficult to adapt to real-time changing voice signals, resulting in a phenomenon that the generated digital human often has asynchrony between audio and picture when speaking. To solve this problem, researchers have begun to explore lip synchronization technology based on deep learning. These technologies realize high-precision lip synchronization effects by analyzing audio signals and video frames, enabling the digital human to present lip shape changes matching voice content when speaking.

Existing lip synchronization technology is generally implemented based on Wav2Lip technology, but has problems that a model is difficult to converge and cannot adapt to multi-language environments.

### SUMMARY

The present application provides a method for synchronizing digital human voice and lip movements to solve the problems in existing technologies that the matching degree between voice and lip movements of a generated digital human is not high and the digital human cannot adapt to multi-language environments.

The method comprises:
acquiring a source video, and preprocessing the source video to obtain audio data and image data;
performing synchronization processing on audio encoding features and image encoding features by using a lip synchronization model to obtain synchronization features, wherein the audio encoding features are output by the lip synchronization model from the audio data, the image encoding features are obtained by the lip synchronization model performing image division, feature fusion and feature encoding on the image data, and the synchronization processing comprises linear feature projection and feature similarity calculation; and
performing video generation according to the synchronization features to obtain a target video.

It can be known from the above content that the present application provides a method for synchronizing digital human voice and lip movements. The method comprises acquiring a source video, and preprocessing the source video to obtain audio data and image data; performing synchronization processing on audio encoding features and image encoding features by using a lip synchronization model to obtain synchronization features, wherein the audio encoding features are output by the lip synchronization model from the audio data, the image encoding features are output by the lip synchronization model from the image data, and the synchronization processing comprises linear feature projection and feature similarity calculation; and performing video generation according to the synchronization features to obtain a target video. The present application solves the problems in existing technologies that the matching degree between voice and lip movements of a generated digital human is not high and the digital human cannot adapt to multi-language environments through the above method.

### BRIEF DESCRIPTION OF THE DRAWINGS

To more clearly illustrate the technical solutions of the present application, the drawings required for the embodiments will be briefly introduced below. Obviously, for those of ordinary skill in the art, other drawings can also be obtained based on these drawings without exerting creative labor.

FIG. 1 is a flow chart of a method for synchronizing digital human voice and lip movements of the present application;

FIG. 2 is a schematic diagram of a lip synchronization model in the method for synchronizing digital human voice and lip movements of the present application;

FIG. 3 is a schematic diagram of an image processing module in the method for synchronizing digital human voice and lip movements of the present application;

FIG. 4 is a schematic diagram of an audio processing module in the method for synchronizing digital human voice and lip movements of the present application;

FIG. 5 is a schematic diagram of a synchronization processing module in the method for synchronizing digital human voice and lip movements of the present application;

FIG. 6 is a training flow chart of the lip synchronization model in the method for synchronizing digital human voice and lip movements of the present application;

FIG. 7 is a flow chart of a convergence mode of the lip synchronization model in the method for synchronizing digital human voice and lip movements of the present application;

FIG. 8 is a flow chart of positive sample training and negative sample training in the method for synchronizing digital human voice and lip movements of the present application;

FIG. 9 is a flow chart of preprocessing in the method for synchronizing digital human voice and lip movements of the present application.

### DETAILED DESCRIPTION

The following will clearly and completely describe the technical solutions in the embodiments of the present invention with reference to the drawings in the embodiments of the present invention. Obviously, the described embodiments are only a part of the embodiments of the present invention, rather than all the embodiments. Based on the embodiments of the present invention, all other embodiments obtained by those of ordinary skill in the art without making creative labor shall fall within the protection scope of the present invention.

In recent years, a technology called Wav2Lip has attracted wide attention. Wav2Lip is a universal speaker model capable of generating videos with lip synchronization accuracy matching real synchronized videos. Its core architecture includes a generator and two discriminators: an expert lip synchronization discriminator and a visual quality discriminator. The expert lip synchronization discriminator is responsible for accurately judging the synchronization between sound and mouth shape in the video, while the visual quality discriminator is used to improve picture quality.

In practical applications, such as lip synchronization of videos recorded by hand outdoors, challenges still exist. These challenges include the diversity of expressions of characters in the video, changes in lighting, occlusion problems, and different speaking styles. To improve the robustness and accuracy of the generation network, researchers have proposed a method of using an expert discriminator to correct the generation network. This method uses a pre-trained expert-level lip synchronization discriminator to punish the inaccurate generation of the generation network during training, thereby improving the lip synchronization quality of the generated frames.

However, the expert lip synchronization discriminator is prone to mode collapse during the training process, especially when processing large datasets composed of multiple languages. The model is difficult to converge, which brings great difficulties to multi-language applications. In addition, since Wav2Lip is mainly trained on English datasets, its accuracy and robustness may decrease when processing non-English languages, which poses an additional challenge for applications in multi-language environments.

Based on the above problems, the present application provides the following embodiments to solve the above problems.

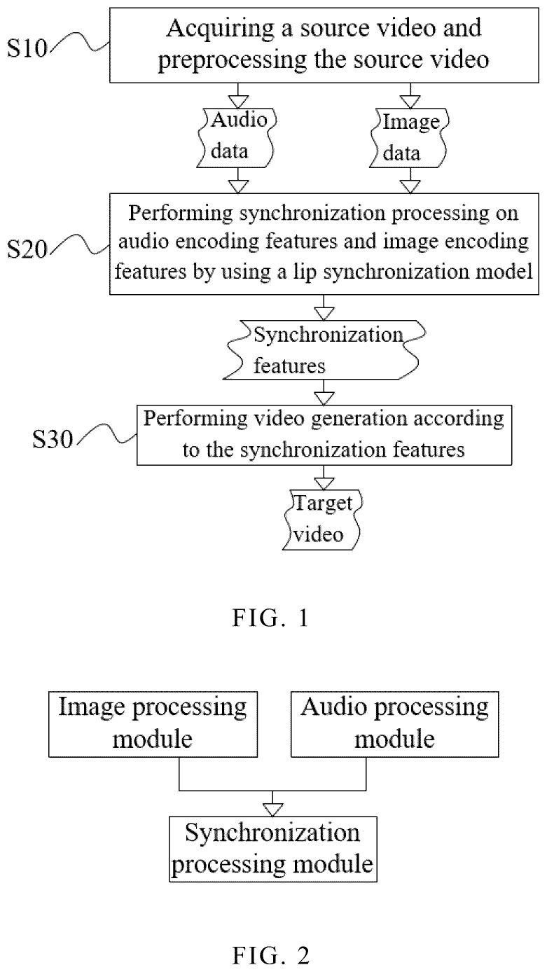

FIG. 1 is a flow chart of a method for synchronizing digital human voice and lip movements of the present application.

As can be seen from FIG. 1, the present embodiment provides a method for synchronizing digital human voice and lip movements, including:

S10, acquiring a source video and preprocessing the source video. Specifically, in the present embodiment, since conventional video data sources are generally obtained from open-source databases, and the quality of such videos is generally uneven, it is needed to perform relevant preprocessing on the video before generating the digital human to meet the standards for digital human generation and thereby improve the quality of digital human generation.

A video with sound generally includes sound and images. Through the preprocessing of the present embodiment, the sound and images are separated, and audio data and image data are obtained accordingly.

FIG. 9 is a flow chart of preprocessing in the method for synchronizing digital human voice and lip movements of the present application.

As can be seen from FIG. 9, further, in some embodiments, the step of preprocessing the source video includes:
S11, extracting source images according to the source video, and performing image framing processing, face detection processing, face region cropping processing, occlusion detection processing, and image masking processing sequentially on the source images to obtain the image data; and
S12, extracting source audio according to the source video, and performing audio framing processing and audio denoising processing sequentially on the source audio to obtain the audio data.

Specifically, in the present embodiment, before generating the digital human, the first step to be performed is video collection to obtain continuous video data containing clear voice and mouth shape changes. Subsequently, the video data are decomposed into individual frames, and at the same time, the audio in the accompanying video is also divided into corresponding audio frames to facilitate synchronization processing.

In the video frame processing stage, face detection technology is first used to locate the face region in each frame, then the face part is accurately cropped and the upper half of the face is masked. This is because lip shape changes mainly occur in this region. Occlusion detection is also performed on the cropped face to ensure that the face region is not occluded by other objects, thereby ensuring the accuracy of lip shape recognition.

Next, denoising processing is performed on the segmented audio frames to extract clearer and more accurate audio features, which are crucial for subsequent lip synchronization analysis. After processing the audio, matching analysis is performed between the extracted audio features and the face regions in the video frames. To make the training model focus more on lip movements rather than other facial features, the upper half of the face is further masked.

It should be noted that step S11 and step S12 are performed synchronously, and there is no sequence between them.

The method further includes:

S20, performing synchronization processing on audio encoding features and image encoding features by using a lip synchronization model. Specifically, in the present embodiment, the lip synchronization model is used to perform synchronization processing on the audio encoding features and the image encoding features, thereby obtaining relevant features for generating digital human videos, i.e., synchronization features.

Correspondingly, the audio encoding features are obtained by inputting the audio data into the lip synchronization model for calculation, and the image encoding features are obtained by inputting the image data into the lip synchronization model for calculation. The audio encoding features and the image encoding features are respectively extracted by the lip synchronization model, and synchronization processing is performed by using the audio encoding features and the image encoding features to combine the sound with the lip shape changes of the character, thereby realizing voice-lip synchronization.

The synchronization processing includes linear feature projection and feature similarity calculation. Through the linear feature projection and the feature similarity calculation, the image features and the audio features are mapped together, thereby realizing the fusion of audio and features.

The method further includes:

S30, performing video generation according to the synchronization features. Specifically, after completing step S20, the synchronization features used to represent the digital human video are obtained, and video generation is performed according to the synchronization features, thereby obtaining the final target video.

FIG. 2 is a schematic diagram of a lip synchronization model in the method for synchronizing digital human voice and lip movements of the present application.

As can be seen from FIG. 2, further, in some embodiments, the lip synchronization model includes:
an image processing module, configured to perform image encoding according to the image data. Specifically, in the present embodiment, the image processing module is used to perform image encoding on the image data in the source video, thereby obtaining features corresponding to the images in the source video, where the obtained features include a plurality of image encoding features.

The lip synchronization model further includes:
an audio processing module, configured to perform audio encoding according to the audio data. Specifically, in the present embodiment, the audio processing module is used to perform audio encoding on the audio data in the source video, thereby obtaining features corresponding to the audio in the source video, where the obtained features include a plurality of audio encoding features.

It should be noted that the image encoding features are in one-to-one correspondence with the audio encoding features.

The lip synchronization model further includes:
a synchronization processing module, configured to perform audio-image synchronization processing according to the audio encoding features and the image encoding features. Specifically, in the present embodiment, the synchronization processing module is used to perform audio-image synchronization processing on the image encoding features obtained by the image processing module and the audio encoding features obtained by the audio processing module, so as to unify the image encoding features and the audio encoding features together, to obtain the synchronization features, and thereby realize the voice-lip synchronization.

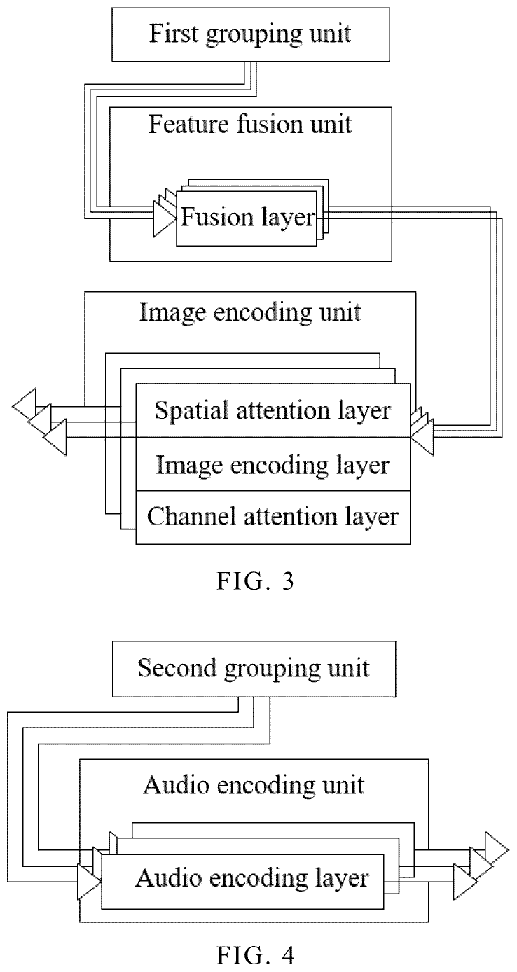

FIG. 3 is a schematic diagram of an image processing module in the method for synchronizing digital human voice and lip movements of the present application.

As can be seen from FIG. 3, further, in some embodiments, the image processing module includes:
a first grouping unit, configured to divide the input image data into a plurality of continuous image sequences. Specifically, in the present embodiment, to better synchronize the voice and lip shape, a single image cannot well reflect the features in the image, so feature extraction cannot be performed using only one image. In the present embodiment, the first grouping unit is used to divide the image data, so as to divide the image data into a plurality of continuous image sequences, and each of the image sequences includes a plurality of continuous image frames, thereby providing an image data basis for subsequent synchronization processing.

The image processing module further includes:
a feature fusion unit, including a plurality of fusion layers arranged in parallel, and the plurality of fusion layers are configured to respectively perform feature fusion on image frames in the plurality of image sequences. Specifically, in the present embodiment, the first grouping unit divides a plurality of the image sequences, and the image sequence includes a plurality of continuous image frames. However, using each image frame alone cannot effectively reflect the lip shape features of the character in the image. Therefore, it is needed to fuse the plurality of image frames in each of the image sequences, thereby obtaining a feature map with multiple image frames. For different image sequences, a plurality of continuous feature maps, i.e., a plurality of first sequences, can be obtained.

The image processing module further includes:
an image encoding unit, including a plurality of image encoding layers arranged in parallel, where the plurality of image encoding layers are in one-to-one correspondence with the plurality of fusion layers, and the plurality of image encoding layers are configured to respectively perform convolution encoding on the plurality of first sequences. Specifically, in the present embodiment, after the feature fusion unit completes the fusion of image frames in all or part of the image sequences, feature encoding is performed on the plurality of fused first sequences, thereby obtaining a plurality of corresponding image encoding features.

Convolution encoding for each image sequence is performed through the image encoding layers arranged in parallel in the image encoding unit. One or more of the image sequences correspond to one of the image encoding layers, and convolution encoding is performed on one or more of the image sequences through one of the image encoding layers, thereby obtaining the image encoding features corresponding to each of the image sequences.

Further, in some embodiments, the image encoding unit further includes a plurality of spatial attention layers arranged in parallel, where the plurality of spatial attention layers are in one-to-one correspondence with the plurality of image encoding layers;
the spatial attention layers are further configured to calculate spatial attention weights according to the first sequences; and
the image encoding layers are further configured to perform convolution encoding according to the first sequences and the spatial attention weights to output the image encoding features.

Specifically, in the present embodiment, the image processing module is improved based on a residual architecture, in which the global average pooling layer is replaced by a spatial attention mechanism. The spatial attention mechanism is used to find the most important part of the face for processing, so as to improve the feature expression of key regions. This improvement enables the network to focus on processing the key regions of lip activities in the image, so as to extract more representative visual features.

Further, in some embodiments, the image encoding unit further includes a channel attention layer; and
the image encoding unit is further configured to divide the first sequences into a plurality of sub-sequences, perform feature encoding processing on each sub-sequence, calculate attention weights corresponding to different sub-sequences through the spatial attention layers, and fuse a plurality of feature encoding processing results based on attention weight calculation results to obtain local feature encodings. Specifically, in the present embodiment, by performing, on the first sequences, sequence division, attention weight calculation, and local feature encoding according to the attention weights, the spatial attention mechanism is introduced into the calculation process of local features. The spatial attention mechanism focuses on the important points of each spatial position in the feature map, so there is a better performance result when calculating the attention of local regions.

The image encoding unit is further configured to divide the local feature encodings into a plurality of sub-sequences, perform feature encoding processing on each sub-sequence, calculate attention weights corresponding to different sub-sequences through a preset spatial attention module, and fuse a plurality of feature encoding processing results based on attention weight calculation results to obtain local feature encodings. Specifically, in the present embodiment, the processing of the local feature encodings by the image encoding unit is the same as the processing of the first sequences described above, both involving local feature analysis on feature encodings. However, the difference from the above lies in that after completing the feature analysis of the local feature encodings, the obtained feature encodings need to be iteratively updated, cyclic local feature analysis is performed on the updated feature encodings, and the obtained local feature encodings are independently output after each round of local feature analysis.

The image encoding unit is further configured to calculate attention weights for the plurality of local feature encodings through the channel attention layer, perform feature processing based on attention weight calculation results to obtain global feature encodings, and fuse the plurality of local feature encodings with the global feature encodings to obtain the image encoding features. Specifically, in the present embodiment, after completing several rounds of local feature analysis, a plurality of local feature encodings can be obtained. Then, the image encoding unit needs to perform further feature analysis on these local feature encodings. The core purpose of the present embodiment is to introduce a channel attention mechanism into the feature analysis process. The channel attention mechanism focuses on calculating the importance of different feature channels relative to the global, so there is a better performance in the effect of calculating global features.

FIG. 4 is a schematic diagram of an audio processing module in the method for synchronizing digital human voice and lip movements of the present application.

As can be seen from FIG. 4, further, in some embodiments, the audio processing module includes:
a second grouping unit, configured to divide the input audio data into a plurality of continuous audio sequences. Specifically, in the present embodiment, to better synchronize the voice and lip shape, a single audio frame cannot well reflect the features in the audio. In addition, the corresponding image processing module performs feature extraction on a plurality of image frames; similarly, feature extraction cannot be performed using only one audio frame. In the present embodiment, the second grouping unit is used to divide the audio data, so as to divide the audio data into a plurality of continuous audio sequences, and each of the audio sequences includes a plurality of continuous audio sub-data, thereby providing an audio data basis for subsequent synchronization processing.

It should be noted that each audio sub-data corresponds to one of the image frames, that is, the number of image frames included in the image sequence is the same as the number of audio sub-data included in the audio sequence.

The audio processing module further includes:
an audio encoding unit, including a plurality of audio encoding layers arranged in parallel, and the plurality of audio encoding layers are configured to respectively perform convolution encoding on the plurality of audio sequences. Specifically, in the present embodiment, convolution encoding for each of the audio sequences is performed through the audio encoding layers arranged in parallel in the audio encoding unit. One or more of the audio sequences correspond to one audio encoding layer, and convolution encoding is performed on one or more of the audio sequences through one audio encoding layer, thereby obtaining the audio encoding features corresponding to each of the audio sequences.

The audio processing module uses a Convolutional Neural Network (CNN) to process audio features. Through a series of convolutional layers, the encoder extracts key features from the audio signal and converts them into a high-dimensional feature vector.

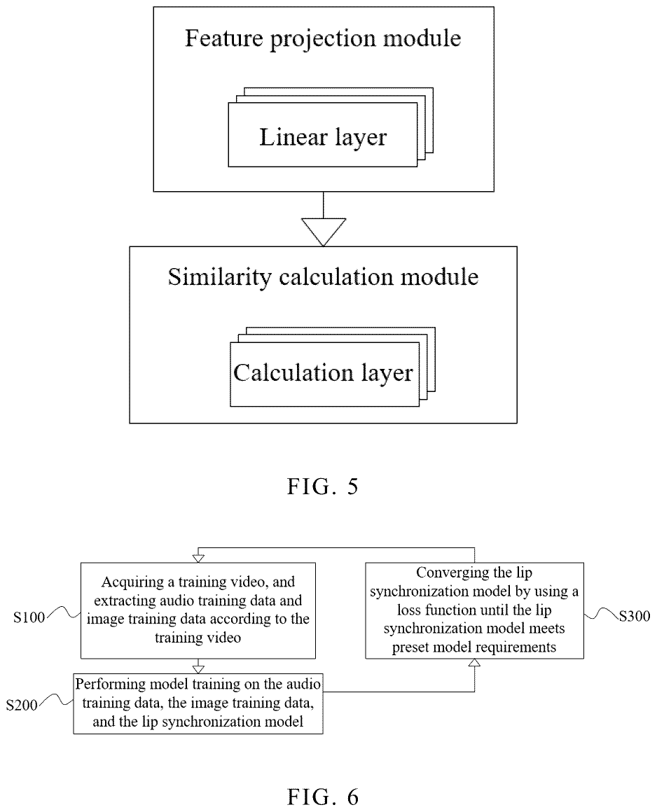

FIG. 5 is a schematic diagram of a synchronization processing module in the method for synchronizing digital human voice and lip movements of the present application.

As can be seen from FIG. 5, further, in some embodiments, the synchronization processing module includes:
a feature projection module, including a plurality of linear layers, where the plurality of linear layers are in one-to-one correspondence with the plurality of image encoding layers and the plurality of audio encoding layers respectively, and the plurality of linear layers are configured to map the image encoding features and the audio encoding features into a multi-modal embedding space; and
a similarity calculation module, including a plurality of calculation layers, where the plurality of calculation layers are in one-to-one correspondence with the plurality of linear layers, and the plurality of calculation layers are configured to calculate the similarity between the image encoding features and the audio encoding features in the multi-modal embedding space, and fuse feature pairs of the image encoding features and the audio encoding features with the highest similarity to obtain the synchronization features.

Specifically, in the present embodiment, after encoding, the audio encoding features and the image encoding features are sent to a linear layer for projection through the feature projection module, so as to map into a shared multi-modal embedding space. That is, two groups of high-dimensional vectors are found to represent the audio encoding features and the image encoding features respectively, and they are projected into a shared latent representation through multi-modal technology, so that the reconstruction deviation of each modality in the common latent space is minimized, and these projection matrices are as sparse as possible. In this space, the network is trained by means of contrastive learning, so that the embedding vectors of synchronized audio-video pairs are closer in the space, while the unsynchronized pairs are farther away.

Optimization algorithms such as back propagation and gradient descent are used to adjust network parameters, so as to minimize the contrastive loss function and improve the accuracy of the model in recognizing lip synchronization. Finally, the network outputs embedding vectors that can represent the synchronization between lip shapes and voices. These vectors can be used in applications such as lip synchronization discrimination, speech enhancement, or digital human animation generation.

### Exemplary Embodiment 1

In the present exemplary embodiment, the method for synchronizing digital human voice and lip movements can determine the audio-video synchronization between mouth movements and voices in a segment of digital human broadcast or singing video, and identify whether the video has the problem of audio-video asynchrony.

### Exemplary Embodiment 2

In the present exemplary embodiment, the method for synchronizing digital human voice and lip movements can determine the character subject uttering the current voice in a segment of digital human broadcast or singing video of multiple digital humans.

FIG. 6 is a training flow chart of the lip synchronization model in the method for synchronizing digital human voice and lip movements of the present application.

As can be seen from FIG. 6, further, in some embodiments, the training process of the lip synchronization model includes:

S100, acquiring a training video, and extracting audio training data and image training data according to the training video;

S200, performing model training on the audio training data, the image training data, and the lip synchronization model; and

S300, converging the lip synchronization model by using a loss function until the lip synchronization model meets preset model requirements.

Specifically, in the present embodiment, before performing model training, it is needed to acquire the training video first, use the training video to perform model training on the lip synchronization model, and use the loss function to converge the lip synchronization model during the model training process until the lip synchronization model meets the preset model requirements.

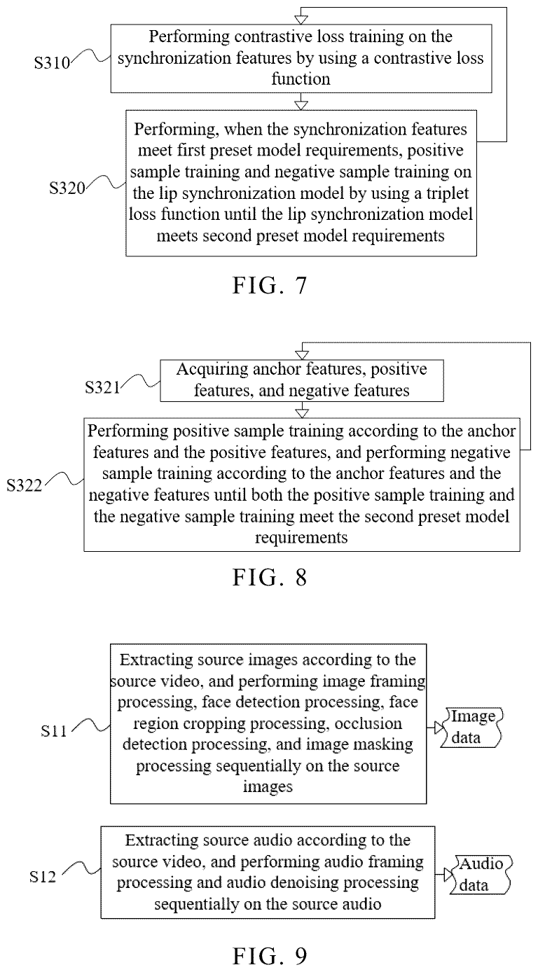

FIG. 7 is a flow chart of a convergence mode of the lip synchronization model in the method for synchronizing digital human voice and lip movements of the present application.

As can be seen from FIG. 7, further, in some embodiments, the step of converging the lip synchronization model by using the loss function includes:

S310, performing contrastive loss training on the synchronization features by using a contrastive loss function. Specifically, in the present embodiment, the loss function includes the contrastive loss function, and the contrastive loss function is used to perform contrastive loss training on the synchronization features, thereby realizing preliminary loss convergence.

The step of converging the lip synchronization model by using the loss function further includes:

S320, performing, when the synchronization features meet first preset model requirements, positive sample training and negative sample training on the lip synchronization model by using a triplet loss function until the lip synchronization model meets second preset model requirements. Specifically, in the present embodiment, the loss function further includes the triplet loss function, and the triplet loss function is used to perform loss convergence again on the lip synchronization model that has completed loss convergence with the contrastive loss function, thereby enhancing the confidence of the model.

FIG. 8 is a flow chart of positive sample training and negative sample training in the method for synchronizing digital human voice and lip movements of the present application.

As can be seen from FIG. 8, further, in some embodiments, the step of performing positive sample training and negative sample training on the lip synchronization model includes:

S321, acquiring anchor features, positive features, and negative features, wherein the anchor features are randomly selected image features or audio features, the positive features are image features or audio features matching the anchor features, and the negative features are image features or audio features not matching the anchor features; and

S322, performing positive sample training according to the anchor features and the positive features, and performing negative sample training according to the anchor features and the negative features until both the positive sample training and the negative sample training meet the second preset model requirements.

Specifically, in the present embodiment, loss convergence using the triplet loss function mainly includes the positive sample training and the negative sample training. The positive sample training and the negative sample training are embodied in that the anchor features and the positive features are used for positive sample training, and the anchor features and the negative features are used for negative sample training, thereby realizing loss convergence of the triplet loss function.

Exemplarily, the loss convergence of the lip synchronization model can be understood as the following two stages.

### First Stage: Contrastive Loss Training

$$Contrastive Loss = \frac{1}{N} {\sum }_{n = 1}^{n} y {d}^{2} + ( 1 - y ) {max ( margin - d , 0 )}^{2}$$

In the initial stage of training, the model only uses matched audio-video data pairs for contrastive loss training. Contrastive loss is widely used in unsupervised learning. This loss function is mainly used in dimensionality reduction: samples that are originally similar remain similar in the feature space after dimensionality reduction (feature extraction); and samples that are originally dissimilar remain dissimilar in the feature space after dimensionality reduction. Similarly, this loss function can also well express the matching degree of paired samples. Here, d represents the Euclidean distance between the features of two samples, y is a label indicating whether the two groups of samples are matched, and m is a set threshold. Distances exceeding m are regarded as having a loss of 0, that is, if two dissimilar features are far apart, the contrastive loss should be very low. The goal of this stage is to learn a feature space where the synchronized audio-video feature vectors are close to each other, while the unsynchronized feature vectors are far apart. The most important point is to use a similarity matrix to calculate the loss. The similarity matrix is calculated at the batch level, which means that all sample pairs in a batch are considered at the same time. By constructing a similarity matrix, the model can compare the similarity between one sample and all other samples in the batch at the same time. This is an innovative idea in multi-modal alignment approach. This contrastive learning strategy helps the model learn to distinguish between positive samples and negative samples, because mismatched sample pairs provide rich negative sample information.

### Second Stage: Fine-Tuning

On the basis of the first stage, the training in the second stage performs fine-tuning by introducing mismatched audio-video data pairs to improve the generalization performance of the model. The mismatched audio-video data pairs include two cases: one is audio-video frames from the same video but not corresponding in time; the other is random combinations of audio and video frames from different videos. These mismatched data pairs are randomly selected according to a certain probability to simulate the asynchrony that may be encountered in the real world.

$$Triplet Loss = max ( d ( anchor , positive ) - d ( anchor , negative ) + α , 0 )$$

In the second stage, a triplet loss function is used to process both matched and mismatched audio-video data pairs at the same time. The input is a triplet, including an Anchor example, a Positive example, and a Negative example. By optimizing the distance between the anchor feature and the positive feature to be smaller than the distance between the anchor feature and the negative feature, the similarity calculation between samples is realized. The triplet loss function can simultaneously optimize the model learning of positive samples for matched pairs and negative samples for mismatched pairs, thereby further distinguishing synchronized and unsynchronized data in the feature space. The design of this loss function helps the model better understand the complex relationship between audio data and video data and improve its ability to recognize unseen data.

Through the training of these two stages, the lip synchronization network can not only effectively learn from the data in the training set, but also accurately identify the synchronization of new and unseen audio-video data pairs, thereby demonstrating better robustness and adaptability in practical applications.

In actual use, the voice-lip synchronization network no longer participates in training during the digital human training process. The digital human generation network forms the input of the voice-lip synchronization network by using five consecutive frames generated from voice. After passing through the voice-lip synchronization network, the corresponding image multi-modal latent space vector and voice multi-modal latent space vector are obtained, and the cosine similarity is calculated using these two vectors to punish the images with inaccurate mouth shapes generated by the generation network, so as to generate digital human videos with more accurate mouth shapes.

The present embodiment has the following advantages:

A deep learning network structure with multi-modal feature alignment is adopted to realize a video-driven method for synchronizing digital human voice and lip movements. Under real-time conditions, whether the continuous frames of the video are synchronized with the audio is determined.

Through the twin-tower design and two-stage training approach, more accurate audio-video synchronization determination is realized, and there is good performance for videos recorded in the wild and better generalization.

From the description of the above implementation manners, those skilled in the art can clearly understand that, for the convenience and conciseness of description, only the division of the above functional modules is taken as an example for illustration. In practical applications, the above functions can be allocated to be completed by different functional modules according to needs.

What is claimed is:

1. A method for synchronizing digital human voice and lip movements, comprising:
acquiring a source video, and preprocessing the source video to obtain audio data and image data;
performing synchronization processing on audio encoding features and image encoding features by using a lip synchronization model to obtain synchronization features, wherein the audio encoding features are output by the lip synchronization model from the audio data, the image encoding features are obtained by the lip synchronization model performing image division, feature fusion and feature encoding on the image data, and the synchronization processing comprises linear feature projection and feature similarity calculation; and
performing video generation according to the synchronization features to obtain a target video;
wherein a training process of the lip synchronization model comprises:
acquiring a training video, and extracting audio training data and image training data according to the training video;
performing model training on the audio training data, the image training data, and the lip synchronization model; and
converging the lip synchronization model by using a loss function until the lip synchronization model meets preset model requirements.

2. The method for synchronizing digital human voice and lip movements according to claim 1, wherein the lip synchronization model comprises:
an image processing module, configured to perform image encoding according to the image data to obtain a plurality of the image encoding features;
an audio processing module, configured to perform audio encoding according to the audio data to obtain a plurality of the audio encoding features; and
a synchronization processing module, configured to perform audio-image synchronization processing according to the audio encoding features and the image encoding features to obtain the synchronization features.

3. The method for synchronizing digital human voice and lip movements according to claim 2, wherein the image processing module comprises:
a first grouping unit, configured to divide the input image data into a plurality of continuous image sequences, wherein each of the image sequences comprises a plurality of continuous image frames;
a feature fusion unit, comprising a plurality of fusion layers arranged in parallel, wherein the plurality of fusion layers are configured to respectively perform feature fusion on image frames in the plurality of image sequences to obtain a plurality of corresponding first sequences; and
an image encoding unit, comprising a plurality of image encoding layers arranged in parallel, wherein the plurality of image encoding layers are in one-to-one correspondence with the plurality of fusion layers, and the plurality of image encoding layers are configured to respectively perform convolution encoding on the plurality of first sequences to obtain a plurality of corresponding image encoding features.

4. The method for synchronizing digital human voice and lip movements according to claim 3, wherein the audio processing module comprises:
a second grouping unit, configured to divide the input audio data into a plurality of continuous audio sequences, wherein each of the audio sequences comprises a plurality of continuous audio sub-data, and each of the audio sub-data corresponds to one of the image frames; and
an audio encoding unit, comprising a plurality of audio encoding layers arranged in parallel, wherein the plurality of audio encoding layers are configured to respectively perform convolution encoding on the plurality of audio sequences to obtain a plurality of corresponding audio encoding features.

5. The method for synchronizing digital human voice and lip movements according to claim 3, wherein the image encoding unit further comprises a plurality of spatial attention layers arranged in parallel, wherein the plurality of spatial attention layers are in one-to-one correspondence with the plurality of image encoding layers;
the spatial attention layers are further configured to calculate spatial attention weights according to the first sequences; and
the image encoding layers are further configured to perform convolution encoding according to the first sequences and the spatial attention weights to output the image encoding features.

6. The method for synchronizing digital human voice and lip movements according to claim 5, wherein the image encoding unit further comprises a channel attention layer;
wherein the image encoding unit is further configured to divide the first sequences into a plurality of sub-sequences, perform feature encoding processing on each sub-sequence, calculate attention weights corresponding to different sub-sequences through the spatial attention layers, and fuse a plurality of feature encoding processing results based on attention weight calculation results to obtain local feature encodings;
divide the local feature encodings into a plurality of sub-sequences, perform feature encoding processing on each sub-sequence, calculate attention weights corresponding to different sub-sequences through a preset spatial attention module, and fuse a plurality of feature encoding processing results based on attention weight calculation results to obtain local feature encodings;
perform iterative updating, and independently output the local feature encodings obtained in each iteration to obtain a plurality of local feature encodings; and
calculate attention weights for the plurality of local feature encodings through the channel attention layer, and perform feature processing based on attention weight calculation results to obtain global feature encodings; and fuse the plurality of local feature encodings with the global feature encodings to obtain the image encoding features.

7. The method for synchronizing digital human voice and lip movements according to claim 4, wherein the synchronization processing module comprises:
a feature projection module, comprising a plurality of linear layers, wherein the plurality of linear layers are in one-to-one correspondence with the plurality of image encoding layers and the plurality of audio encoding layers respectively, and the plurality of linear layers are configured to map the image encoding features and the audio encoding features into a multi-modal embedding space; and
a similarity calculation module, comprising a plurality of calculation layers, wherein the plurality of calculation layers are in one-to-one correspondence with the plurality of linear layers, and the plurality of calculation layers are configured to calculate similarity between the image encoding features and the audio encoding features in the multi-modal embedding space, and fuse feature pairs of the image encoding features and the audio encoding features with the highest similarity to obtain the synchronization features.

8. The method for synchronizing digital human voice and lip movements according to claim 1, wherein a step of converging the lip synchronization model by using the loss function comprises:
performing contrastive loss training on the synchronization features by using a contrastive loss function; and
performing, when the synchronization features meet first preset model requirements, positive sample training and negative sample training on the lip synchronization model by using a triplet loss function until the lip synchronization model meets second preset model requirements.

9. The method for synchronizing digital human voice and lip movements according to claim 8, wherein a step of performing positive sample training and negative sample training on the lip synchronization model comprises:
acquiring anchor features, positive features, and negative features, wherein the anchor features are randomly selected image features or audio features, the positive features are image features or audio features matching the anchor features, and the negative features are image features or audio features not matching the anchor features; and
performing positive sample training according to the anchor features and the positive features, and performing negative sample training according to the anchor features and the negative features until both the positive sample training and the negative sample training meet the second preset model requirements.

10. The method for synchronizing digital human voice and lip movements according to claim 1, wherein a step of preprocessing the source video comprises:
extracting source images according to the source video, and performing image framing processing, face detection processing, face region cropping processing, occlusion detection processing, and image masking processing sequentially on the source images to obtain the image data; and
extracting source audio according to the source video, and performing audio framing processing and audio denoising processing sequentially on the source audio to obtain the audio data.
